(19) United States
(12) Patent Application Publication
(10) Pub. No.: US 2013/0190442 A1
(43) Pub. Date: Jul. 25, 2013

(54) LINEAR LOW DENSITY POLYETHYLENE NANOCOMPOSITE FIBERS AND METHOD OF MAKING THE SAME

(71) Applicants: KHALED MEZGHANI, DHAHRAN (SA); MOHAMMED RIYAZUDDIN FAROOQUI, DHAHRAN (SA); SARFARAZ AHMED FURQUAN, HYDERABAD (IN); MUATAZ ALI ATIEH, DHAHRAN (SA)

(72) Inventors: KHALED MEZGHANI, DHAHRAN (SA); MOHAMMED RIYAZUDDIN FAROOQUI, DHAHRAN (SA); SARFARAZ AHMED FURQUAN, HYDERABAD (IN); MUATAZ ALI ATIEH, DHAHRAN (SA)

(73) Assignee: KING FAHD UNIVERSITY OF PETROLEUM AND MINERALS, DHAHRAN (SA)

(21) Appl. No.: 13/356,510

(22) Filed: Jan. 23, 2012

(51) Int. Cl. C08K 3/04; B29C 47/78; B82Y 30/00; B82Y 40/00

(52) U.S. Cl. 524/496; 524/495; 264/211.1; 264/211.22; 977/742; 977/842; 977/961

(57) ABSTRACT

The linear low density polyethylene nanocomposite fibers are formed from a linear low density polyethylene matrix having carbon nanotubes embedded therein. The addition of the carbon nanotubes enhances the overall toughness of the material, resulting in increases over conventional linear low density polyethylene in the material's tensile strength, elasticity and ductility. The carbon nanotubes constitute between about 0.08% and 1.0% by weight of the linear low density polyethylene nanocomposite fiber. Optimal toughness is found at about 0.3 wt %. The linear low density polyethylene nanocomposite fibers are made by first melting a quantity of linear low density polyethylene, and then blending a quantity of carbon nanotubes into the melted linear low density polyethylene to form a mixture, The mixture is then extruded to form the linear low density polyethylene nanocomposite fibers, which are then spun in a spinneret die to produce the finished linear low density polyethylene nanocomposite fibers.

### BACKGROUND OF THE INVENTION

1. Field of the Invention

The present invention relates to nanocomposites, and particularly to linear low density polyethylene nanocomposite fibers formed from linear low density polyethylene and carbon nanotubes, as well as a method of making the same.

2. Description of the Related Art

Linear low density polyethylene (LLDPE) is a substantially linear polymer (polyethylene), with significant numbers of short branches, commonly made by copolymerization of ethylene with longer-chain olefins. Linear low density polyethylene differs structurally from conventional low density polyethylene (LDPE) because of the absence of long chain branching. The linearity of LLDPE results from the different manufacturing processes of LLDPE and LDPE. In general, LLDPE is produced at lower temperatures and pressures by copolymerization of ethylene and such higher alpha olefins as butene, hexene, or octene. The copolymerization process produces an LLDPE polymer that has a narrower molecular weight distribution than conventional LDPE, and in combination with the linear structure, significantly different rheological properties.

LLDPE has penetrated almost all traditional markets for polyethylene. It is used for plastic bags and sheets (where it allows using lower thickness than comparable LDPE), plastic wrap, stretch wrap, pouches, toys, covers, lids, pipes, buckets and containers, covering of cables, geomembranes, and flexible tubing. The enhancement of mechanical properties of a variety of polymers through the addition of carbon nanotubes is known. However, thus far, LLDPE is not amongst this group of polymers experimented with. Given the wide variety of uses for LLDPE, and its increasing popularity in industry, it would be desirable to be able to form a nanocomposite of LLDPE and carbon nanotubes in order to enhance the material properties of LLDPE.

Thus, linear low density polyethylene nanocomposite fibers and method of making the same solving the aforementioned problems are desired.

### SUMMARY OF THE INVENTION

The linear low density polyethylene nanocomposite fibers are formed from a linear low density polyethylene matrix having carbon nanotubes embedded therein. The addition of the carbon nanotubes enhances the overall toughness of the material, resulting in increases over conventional linear low density polyethylene in the material's tensile strength, elasticity and ductility. The carbon nanotubes constitute between about 0.08% and 1.0% by weight of the linear low density polyethylene nanocomposite fiber. Optimal toughness is found at about 0.3 wt %.

The linear low density polyethylene nanocomposite fibers are made by first melting a quantity of linear low density polyethylene, and then mixing a quantity of carbon nanotubes into the melted linear low density polyethylene to form a mixture. The carbon nanotubes are added to the melted linear low density polyethylene so that the carbon nanotubes constitute up to 1.0% by weight of the mixture. The mixture is then extruded to form the linear low density polyethylene nanocomposite fibers, which are then spun in a spinneret die to produce the finished linear low density polyethylene nanocomposite fibers.

These and other features of the present invention will become readily apparent upon further review of the following specification and drawings.

### BRIEF DESCRIPTION OF THE DRAWINGS

FIG. 1 is a scanning electron microscope micrograph of multi-walled carbon nanotubes suitable for use in making linear low density polyethylene nanocomposite fibers according to the present invention.

FIG. 2 is a graph comparing differential scanning calorimeter plots of pure carbon nanotubes, pure linear low density polyethylene, and linear low density polyethylene nanocomposite fibers according to the present invention.

FIG. 3 is a scanning electron micrograph illustrating distribution of carbon nanotubes in the linear low density polyethylene matrix of linear low density polyethylene nanocomposite fibers according to the present invention.

FIG. 4 is a graph comparing tensile stress-strain curves of pure linear low density polyethylene with linear low density polyethylene nanocomposites with carbon nanotube weight percentages of 0.08%, 0.3% and 1.0%.

FIG. 5 is a plot illustrating the effect of carbon nanotube concentration on the tensile strength of linear low density polyethylene nanocomposite fibers.

FIG. 6 is a plot illustrating the effect of carbon nanotube concentration on the elastic modulus of linear low density polyethylene nanocomposite fibers.

FIG. 7 is a plot illustrating the effect of carbon nanotube concentration on the ductility of linear low density polyethylene nanocomposite fibers.

FIG. 8 is a plot illustrating the effect of carbon nanotube concentration on the toughness of linear low density polyethylene nanocomposite fibers.

FIGS. 9A, 9B and 9C are diagrams illustrating random orientation of carbon nanotubes within a linear low density polyethylene nanocomposite fiber, partially oriented carbon nanotubes within a linear low density polyethylene nanocomposite fiber, and alignment of carbon nanotubes within an elongated linear low density polyethylene nanocomposite fiber, respectively.

Similar reference characters denote corresponding features consistently throughout the attached drawings.

### DETAILED DESCRIPTION OF THE PREFERRED EMBODIMENTS

The linear low density polyethylene nanocomposite fibers are formed from a linear low density polyethylene matrix having carbon nanotubes embedded therein. The addition of the carbon nanotubes enhances the overall toughness of the material, resulting in increases over conventional linear low density polyethylene in the material's tensile strength, elasticity and ductility. The carbon nanotubes constitute between about 0.08% and 1.0% by weight of the linear low density polyethylene nanocomposite fiber. Optimal toughness is found at about 0.3 wt %.

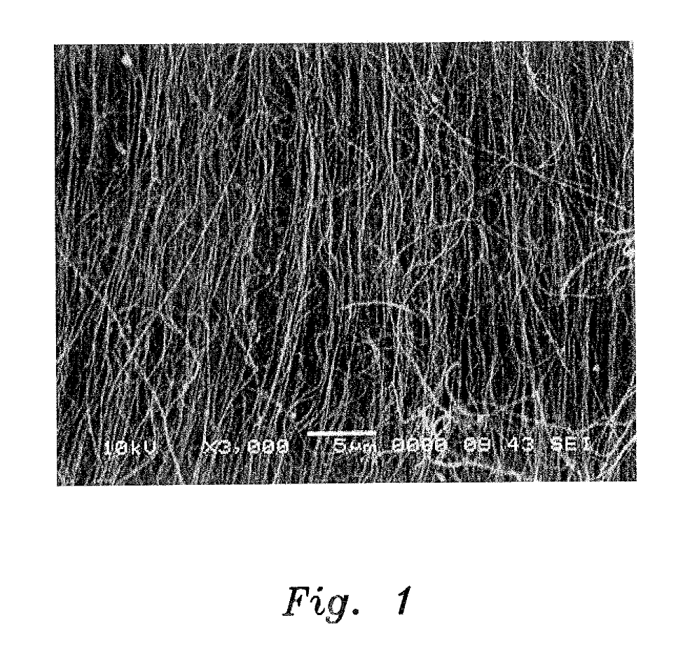

The linear low density polyethylene nanocomposite fibers are made by first melting a quantity of linear low density polyethylene, and then mixing a quantity of carbon nanotubes into the melted linear low density polyethylene to form a mixture. The linear low density polyethylene is preferably provided in pellet form, having a melt index of about 0.8 g/10 min and a density of about 0.921 g/cm³. The carbon nanotubes are preferably multi-walled carbon nanotubes, having diameters between about 20 nm and about 50 nm, and lengths of about 200 μm tin to about 500 μm. The carbon nanotubes may be produced through chemical vapor deposition or any other suitable formation process. FIG. 1 is a scanning electron microscope (SEM) micrograph image of the aligned multi-walled carbon nanotubes, produced by chemical vapor deposition, used in the experiments to be described below.

The carbon nanotubes are added to the melted linear low density polyethylene so that the carbon nanotubes constitute up to 1.0% by weight of the mixture. The carbon nanotubes are added at controlled temperature and speed. The mixture is then extruded to form the linear low density polyethylene nanocomposite fibers, which are then spun in a spinneret die to produce the finished linear low density polyethylene nanocomposite fibers.

Any suitable type of extruder may be utilized, such as a Thermo Scientific® HAAKE PolyLab QC mixer/extruder system, which is a twin screw extruder having a length of 40D, with seven extrusion zones. In order to obtain the different proportions of linear low density polyethylene and carbon nanotubes studied (to be discussed in detail below), two separate computerized control feeders were used for feeding the linear low density polyethylene and carbon nanotubes into the extruder.

The temperature in the first zone of the extruder was maintained at about 160° C. and the temperature in the second zone was maintained at about 180° C. Following extrusion, the extruded fibers were spun in a spinneret die to produce the finished linear low density polyethylene nanocomposite fibers. The spinneret die was maintained at a pressure of about 20 bar and a temperature of about 275° C. It should be understood that any suitable type of spinneret die may be utilized. For the following testing, a spinneret die having ten spinneret holes of 750 μm diameter each was used. Following extrusion, the fibers were drawn at room temperature.

In the following, a Mettler Toledo® Differential Scanning Calorimeter DSC 882 was used to confirm the concentration of carbon nanotubes (CNTs). The samples of 14 to 16 mg were heated from between about 20° C. and about 600° C., with a heating rate of about 10° C./min under about 100 ml nitrogen flow. The weight of the linear low density polyethylene (LLDPE)/CNT fibers were measured with a microbalance with 0.1 μg accuracy.

An Instron® 5569 tensile testing machine was used for testing the mechanical properties of the LLDPE/CNT fibers. All fibers of different concentrations were tested with a gauge length of 50 mm and strain rate of 50 mm/min. The modulii of elasticity obtained for the fibers were determined from the initial slope of the tensile curves.

As noted above, the nanocomnposite fibers were produced by a twin screw extruder. The LLDPE and CNTs were fed by two separately controlled feeders. The speed of each feeder was separately calibrated to deliver the required amount of LLDPE and CNT into the twin screw extruder. Three different concentrations of 0.08 wt %, 0.3 wt % and 1.0 wt % CNT were added to produce the LLDPE/CNT nanocomposite fibers. The amount of CNTs present in the LLDPE/CNT fibers was confirmed with the DSC analysis.

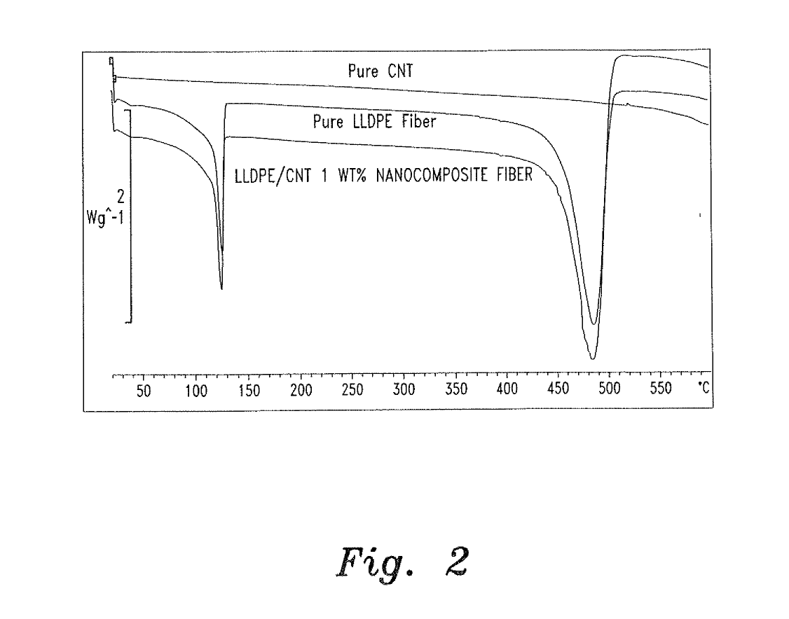

In FIG. 2, the pure CNT curve shows that the CNT material remains stable up to 600° C. Thus, CNTs in any composite will not be affected at temperatures of up to 600° C. In the case of pure LLDPE fibers, the DSC curve has two peaks: the first corresponding to the melting temperature and the second corresponding to the decomposition temperature. The melting temperature for pure LLDPE fiber was about 125° C. and the decomposition peak was at 490° C.

The DSC pan containing pure LLDPE fibers was weighed both before and after the DSC test. The result confirmed that the LLDPE fibers were totally decomposed after the DSC run, Similarly, the heating curve of the LLDPE/CNT fibers with 1.0 wt % CNTs showed the total decomposition of the LLDPE material. Thus, in any LLDPE/CNT composite fiber, the LLDPE, will decompose before it reaches 600° C. The only component remaining is the CNT component. Thus, the weight measured after the DSC test of the LLDPE/CNT fibers is the amount of CNTs. The weight percent of CNTs determined from the DSC test was in agreement with the weight percent being fed through the two separately controlled feeders.

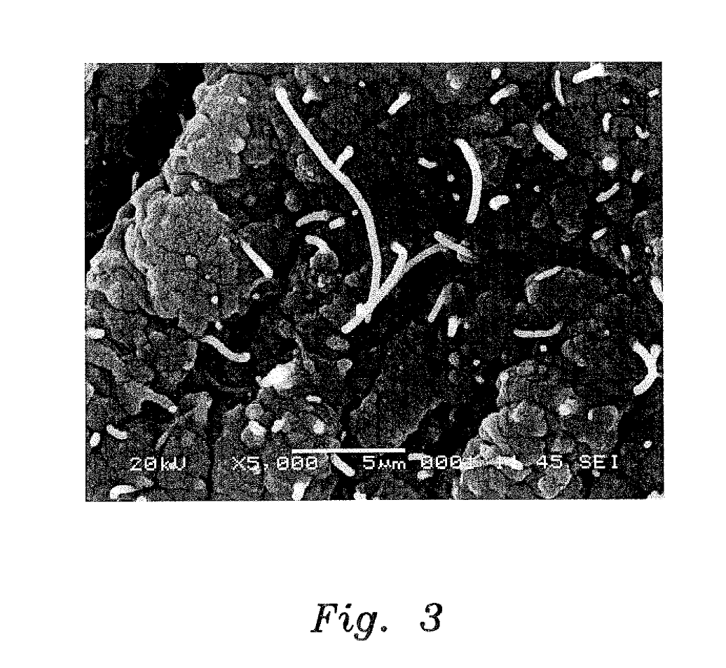

The mixture of LLDPE and CNTs passed through three consecutive stages of mixing, resulting in the effective distribution of CNTs in the LLDPE matrix shown in the SEM micrograph of FIG. 3. In FIG. 3, the white regions represent the CNTs pulled out of the LLDPE matrix. It can be seen that there is no agglomeration of CNTs. The CNTs are well distributed and aligned in the LLDPE matrix. The alignment of CNTs in the composite is due to the drawing of the LLDPE/CNT fibers.

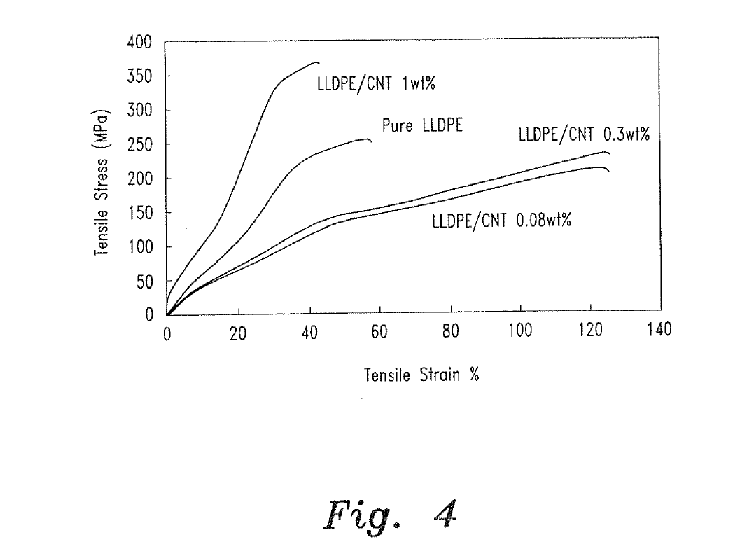

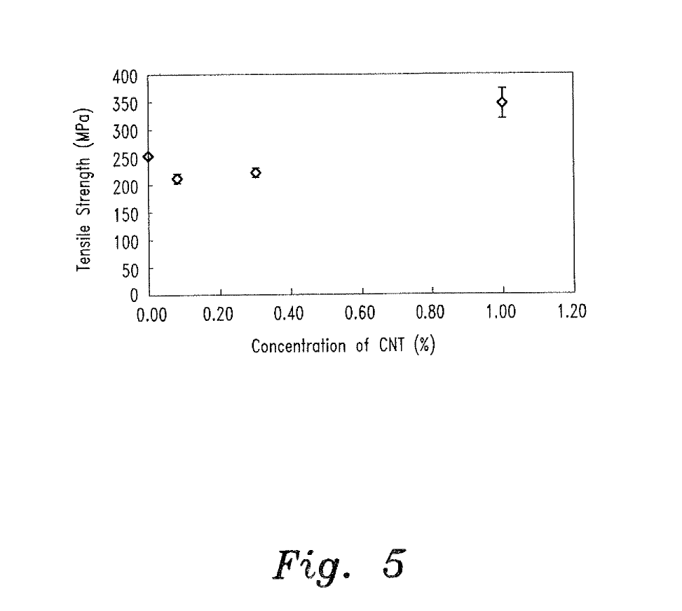

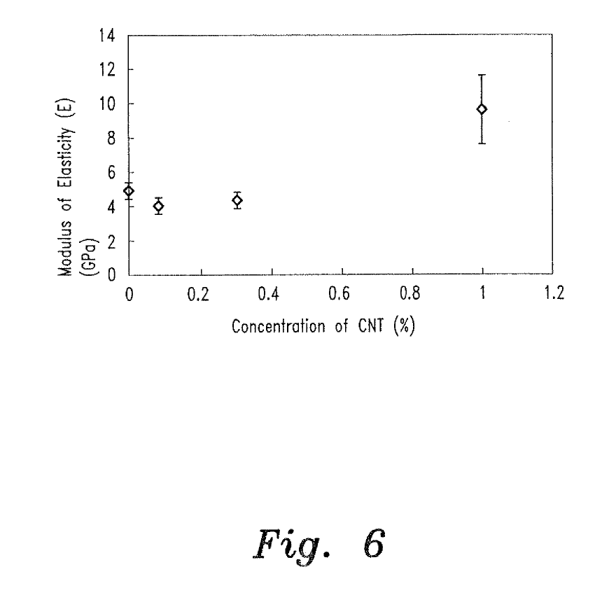

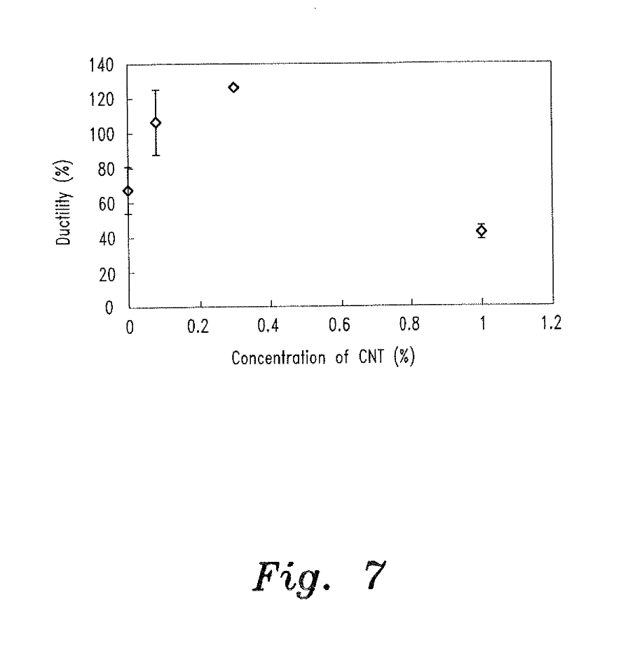

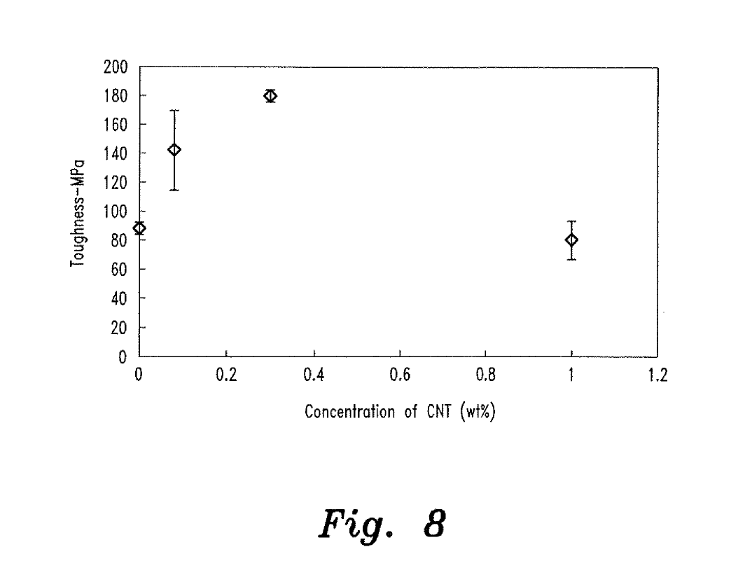

The distribution and alignment of CNTs in the LLDPE matrix affects the mechanical properties of the LLDPE fibers, such as tensile strength, elastic modulus, toughness and ductility. The tensile stress strain curves for different loadings of CNTs are shown in FIG. 4. From FIG. 5, it can be seen that the loading of 1.0 wt % CNTs in the LLDPE matrix has increased the tensile strength to 350 MPa, which is about a 38% increment when compared to pure LLDPE. Similarly, the modulus of elasticity improved to 10 GPa, which is twice the modulus of pure LLDPE fibers, as shown in FIG. 6. These increments result in a small decrease in the ductility and toughness, as shown in FIGS. 7 and 8, respectively. The enhancement in the tensile strength and modulus of the LLDPE/CNT fibers (1.0 wt %) fibers is due to the good distribution and alignment of CNTs in the LLDPE matrix, as shown by the SEM micrograph of FIG. 3.

In FIG. 3, the CNTs are shown being partially pulled out of the matrix, though it can be seen that the CNTs are well coated by the LLDPE matrix. This indicates a high interfacial bonding between the LLDPE matrix and the CNT surface. Thus, the load is transferred from the LLDPE matrix to the CNTs, which consequently increases the tensile strength of the LLDPE/CNT (1.0 wt %) fibers. Further, according to the mixture rule, the expected modulus for LLDPE/CNT fibers with 1.0 wt % CNTs is 16.5 GPa. The modulus obtained for the same fiber's experimental value is very close to this theoretical value. This indicates excellent alignment of CNTs in the LLDPE/CNT fiber with 1.0 wt % CNT.

As noted above, the CNT loadings of 0.08 wt % and 0.3 wt % CNT have slightly decreased tensile strength of 209 MPa and 224 MPa, respectively, as shown in FIG. 5. As shown, the pure LLDPE fibers have a tensile strength of 254 MPa. Similarly, a slight decrement in the modulus is observed for concentrations of 0.08 wt % and 0.3 wt % of CNTs, as shown in FIG. 6. While the pure LLDPE fiber has a modulus of 4.9 GPa, the fibers with 0.08 wt % and 0.3 wt % CNT have a modulus of 3.9 GPa and 4.3 GPa, respectively. The decrease in the modulus for these smaller quantities of CNTs is due to partial alignment of CNTs in the matrix.

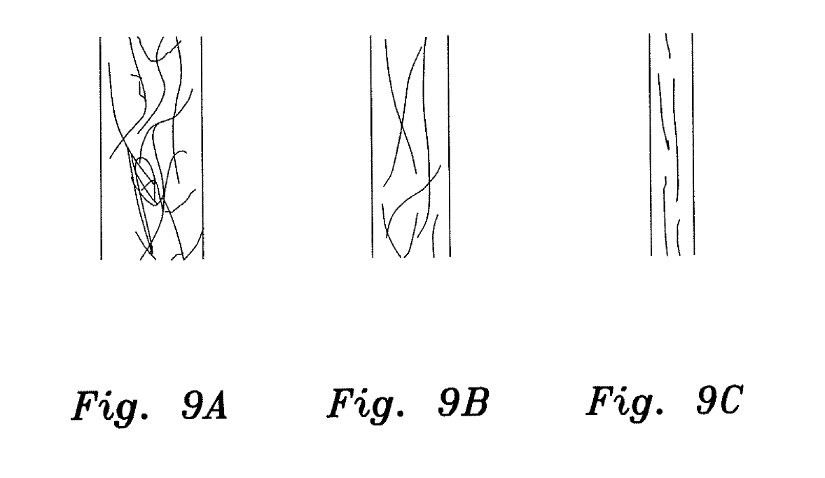

The random orientation of CNTs in the LLDPE matrix is schematically shown in FIGS. 9A and 9B. During the tensile testing of these fibers, the initial load is not fully transferred from the LLDPE matrix to the CNTs because the CNTs are partially aligned along the direction of stress. Further, they act as a nano-flaw in the composite fibers. However, further elongation of the LLDPE/CNT nanocomposite fibers with 0.08 wt % and 0.3 wt % CNT aligns the CNT in the matrix, as shown in FIG. 9C. Consequently, the CNTs hold the LLDPE matrix together, increasing its ductility and toughness, as shown in FIGS. 7 and 8.

The ductility of the pure LLDPE fiber is 57% (shown in FIG. 7), whereas the ductility of the LLDPE/CNT fibers with 0.08 wt % and 0.3 wt % CNT are 107% and 127%, respectively. Thus, up to 122% improvement in ductility is possible with the addition of 0.3 wt % CNTs to the LLDPE fiber. Due to this large elongation difference, the true stress of LLDPE/CNT fibers with 0.3 wt % is much higher than that of the pure LLDPE fibers. A similar effect is shown in FIG. 8, in which the toughness of pure LLDPE fibers are improved by 63% and 105% with the addition of 0.08 wt % and 0.3 wt % CNT, respectively. The toughness of the pure LLDPE fibers was observed to be 88 MPa, while the LLDPE/CNT fibers with 0.08 wt % and 0.3wt % CNT have toughness of 143 MPa and 180 MPa, respectively.

It is to be understood that the present invention is not limited to the embodiments described above, but encompasses any and all embodiments within the scope of the following claims.

We claim:

1. A linear low density polyethylene nanocomposite fiber, comprising a linear low density polyethylene matrix having carbon nanotubes embedded therein, wherein the carbon nanotubes constitute up to 1.0% by weight of the linear low density polyethylene nanocomposite fiber.

2. The linear low density polyethylene nanocomposite fiber as recited in claim 1, wherein the carbon nanotubes constitute about 0.3% by weight of the linear low density polyethylene nanocomposite fiber.

3. The linear low density polyethylene nanocomposite fiber as recited in claim 1, wherein the carbon nanotubes constitute about 0.08% by weight of the linear low density polyethylene nanocomposite fiber.

4. The linear low density polyethylene nanocomposite fiber as recited in claim 1, wherein the carbon nanotubes constitute less than 1.0% by weight of the linear low density polyethylene nanocomposite fiber.

5. The linear low density polyethylene nanocomposite fiber as recited in claim 1, wherein the carbon nanotubes constitute between about 0.08% and about 1.0% by weight of the linear low density polyethylene nanocomposite fiber.

6. A method of making linear low density polyethylene nanocomposite fibers, comprising the steps of:
melting a quantity of linear low density polyethylene;
blending a quantity of carbon nanotubes into the melted linear low density polyethylene to form a mixture, the carbon nanotubes constituting less than 1.0% by weight of the mixture; and
extruding the mixture to form the linear low density polyethylene nanocomposite fibers.

7. The method of making linear low density polyethylene nanocomposite fibers as recited in claim 6, wherein the step of melting the linear low density polyethylene further comprises melting pellets of linear low density polyethylene.

8. The method of making linear low density polyethylene nanocomposite fibers as recited in claim 6, further comprising the step of spinning the linear low density polyethylene nanocomposite fibers in a spinneret die.

9. The method of making linear low density polyethylene nanocomposite fibers as recited in claim 8, wherein the step of spinning is performed under a pressure of about 20 bar.

10. The method of making linear low density polyethylene nanocomposite fibers as recited in claim 9, wherein the step of spinning is performed at a temperature of about 275° C.

11. The method of making linear low density polyethylene nanocomposite fibers as recited in claim 6, wherein the carbon nanotubes constitute about 0.3% by weight of the mixture.

12. The method of making linear low density polyethylene nanocomposite fibers as recited in claim 6, wherein the carbon nanotubes constitute about 0.08% by weight of the mixture.

13. The method of making linear low density polyethylene nanocomposite fibers as recited in claim 6, wherein the step of extruding the mixture comprises extrusion through a twin screw extruder having seven extrusion zones.

14. The method of making linear low density polyethylene nanocomposite fibers as recited in claim 13, further comprising the step of maintaining the first extrusion zone at a temperature of about 160° C.

15. The method of making linear low density polyethylene nanocomposite fibers as recited in claim 14, further comprising the step of maintaining the second extrusion zone at a temperature of about 180° C.

16. The method of making linear low density polyethylene nanocomposite fibers as recited in claim 6, wherein the linear low density polyethylene has a density of about 0.921 g/cm³.

17. The method of making linear low density polyethylene nanocomposite fibers as recited in claim 6, wherein the linear low density polyethylene has a melt index of about 0.8 g/10 min.

18. The method of making linear low density polyethylene nanocomposite fibers as recited in claim 6, wherein the carbon nanotubes have a diameter of between about 20 nm and 50 nm.
